(19) United States
(12) Patent Application Publication
(10) Pub. No.: US 2016/0378408 A1
(43) Pub. Date: Dec. 29, 2016

(54) IMAGE FORMATION APPARATUS, IMAGE FORMATION SYSTEM, AND IMAGE FORMATION METHOD

(71) Applicant: Oki Data Corporation, Tokyo (JP)

(72) Inventor: Yoko ASANO, Tokyo (JP)

(73) Assignee: Oki Data Corporation, Tokyo (JP)

(21) Appl. No.: 15/158,711

(22) Filed: May 19, 2016

(30) Foreign Application Priority Data
Jun. 24, 2015 (JP) 2015-126290

(51) Int. Cl. G06F 3/12

(52) U.S. Cl. CPC G06F 3/128; G06F 3/1205; G06F 3/1236; G06F 3/1292; G06F 3/1228

(57) ABSTRACT

An image formation apparatus include a first transmission section, a fist reception section, and a printing section. The first transmission section sends first print setting information to an external device according to a request from the external device. The first reception section receives second print setting information from the external device, the second print setting information being obtained by changing the first print setting information. The printing section, upon receiving print data from the external device, processes the print data based on the second print setting information.

### CROSS REFERENCE TO RELATED APPLICATIONS

This application claims priority based on 35 USC 119 from prior Japanese Patent Application No. 2015-126290 filed on Jun. 24, 2015, entitled “IMAGE FORMATION APPARATUS, INFORMATION PROCESSING APPARATUS, INFORMATION PROCESSING PROGRAM, INFORMATION PROCESSING METHOD, AND INFORMATION PROCESSING SYSTEM”, the entire contents of which are incorporated herein by reference.

### BACKGROUND OF THE INVENTION

1. Field of the Invention The disclosure relates to an image formation apparatus, an image formation system, an image formation method, an information processing apparatus, an information processing program, an information processing method, and an information processing system.

2. Description of Related Art

In the process of printing a file by sending the file from a personal computer (PC) to a printer, a printer driver installed in the PC converts the file into print data described with a page description language (PDL) such as PostScript (registered trademark) , and then the print data is transmitted to the printer as a printing job. Meanwhile, a process called direct printing is known, in which a file without being converted into PDL data by the printer driver is directly transferred to and printed by a printer (Patent Literature 1: Japanese Patent Laid-open Publication No. 2011-096000), for example).

### SUMMARY OF INVENTION

However, direct printing has a problem in making it difficult to configure the print settings on a file-by-file basis.

An object of an embodiment of the invention is to facilitate the configuring of print settings on a file-by-file basis in direct printing.

A first aspect of the invention is an image formation apparatus that includes: a first transmission section that sends first print setting information to an external device according to a request from the external device; a first reception section that receives second print setting information from the external device, the second print setting information being obtained by changing the first print setting information; and a printing section that, when print data is received from the external device, processes the print data based on the second print setting information.

A second aspect of the invention is an information processing apparatus that includes: a first communication section that requests first print setting information from an image formation device and acquires the first print setting information from the image formation apparatus; a second communication section that sends, to the image formation apparatus, second print setting information obtained by changing the first print setting information; and a third communication section that sends print data to the image formation apparatus.

A third aspect of the invention is an information processing program that causes a computer to execute: a request for first print setting information from an image formation device and to acquire the first print setting information from the image formation apparatus; a sending of the image formation apparatus second print setting information obtained by changing the first print setting information; and a sending of print data to the image formation apparatus.

A fourth aspect of the invention is an information processing method that includes: requesting first print setting information from an image formation apparatus and acquiring the first print setting information from the image formation apparatus; sending the image formation apparatus second print setting information obtained by changing the first print setting information; and sending print data to the image formation apparatus.

A fifth aspect of the invention is an image processing system that includes: an image formation apparatus; and an information processing apparatus. The image formation apparatus includes: a storage that stores one or plural pieces of print setting information; a first transmission section that sends the print setting information read from the storage to the information processing apparatus; a first reception section that receives print data including location information from the information processing apparatus; and a printing section that specifies the print setting information in the storage based on the location information included in the print data and processes the print data based on the specified print setting information. The information processing apparatus includes: a display section that displays the one or plural pieces of print setting information; a selection input section that receives the selection of at least one of the one or plural pieces of print setting information displayed by the display section; and a second reception section that sends print data including the location information of the selected piece of print setting information.

A sixth aspect of the invention is an image formation system comprising an image formation apparatus and information processing apparatus. The image formation apparatus comprises: a storage that stores first print setting information therein; a first transmission section that sends the first print setting information to the information processing apparatus; a first reception section that receives second print setting information from the information processing apparatus; and a printing section that, when print data is received from the information processing apparatus, processes the print data based on the second print setting information. The information processing apparatus comprises: a first communication section that acquires the first print setting information from the image formation apparatus; a second communication section that sends the second print setting information and the print data to the image formation apparatus, wherein the second print setting information is obtained by changing the first print setting information.

A seventh aspect of the invention is an image formation method comprising: sending the first print setting information; receiving the first print setting information; sending second print setting information obtained by changing the first print setting information; receiving the second print setting information; and sending print data; and processing the print data based on the second print setting information, upon receiving the print data.

According to the aforementioned aspect(s) of the invention, it is possible to easily configure the print settings on a file-by-file basis in direct printing.

### BRIEF DESCRIPTION OF THE DRAWINGS

FIG. 1 is a diagram illustrating a schematic configuration example of an information processing system.

FIG. 2 is a diagram illustrating a schematic configuration example of printing data.

FIG. 3 is a diagram illustrating a function block example of a printer according to an embodiment of the invention.

FIG. 4 is a diagram illustrating a schematic configuration example of the storage in FIG. 3.

FIG. 5 is a diagram illustrating a functional block example of a mobile terminal according to the embodiment of the invention.

FIG. 6 is a diagram illustrating an example of an operation procedure of a remote connection in the information processing system.

FIG. 7 is a diagram illustrating an example of an operation procedure of a print setting information registration in the information processing system.

FIG. 8 is a first diagram illustrating a screen example.

FIG. 9 is a second diagram illustrating a screen example.

FIG. 10 is a third diagram illustrating a screen example.

FIG. 11 is a fourth diagram illustrating a screen example.

FIG. 12 is a fifth diagram illustrating a screen example.

FIG. 13 is a diagram illustrating an example of an operation procedure of a printing in the information processing system.

FIG. 14 is a sixth diagram illustrating a screen example.

FIG. 15 is a seventh diagram illustrating a screen example.

FIG. 16 is a diagram illustrating an example of the operation procedure of a summary display in the information processing system.

FIG. 17 is an eighth diagram illustrating a screen example.

FIG. 18 is a diagram illustrating a schematic configuration example of the storage in FIG. 3.

### DETAILED DESCRIPTION OF EMBODIMENTS

Descriptions are provided hereinbelow for embodiments based on the drawings. In the respective drawings referenced herein, the same constituents are designated by the same reference numerals and duplicate explanation concerning the same constituents is omitted. The invention is not limited to the following embodiments. All of the drawings are provided to illustrate the respective examples only. The invention is not limited to the arrangement, dimensions, and dimensional proportions of the constituent components illustrated in each drawing. The description is given in the following order.

### 1. Embodiment

An example of direct printing through communication between a printer and a mobile terminal

### 2. Modifications

Modification Example 1: an example of direct printing by connecting a printer and plural mobile terminals through USB connectors

Modification Example 2: an example of direct printing through communication between a printer and plural mobile terminals

Modification Example 3: an example of direct printing by communication between a printer and an information processing apparatus other than mobile terminals

Modification Example 4: an example of direct printing by communication between a mobile terminal and a facsimile or scanner machine

Modification Example 5: a first variation of the tree structure in a storage of the printer.

Modification Example 6: a second variation of the tree structure in a storage of the printer.

Modification Example 7: an example of direct printing implemented by hardware or software.

### 1. First Embodiment

### Configuration

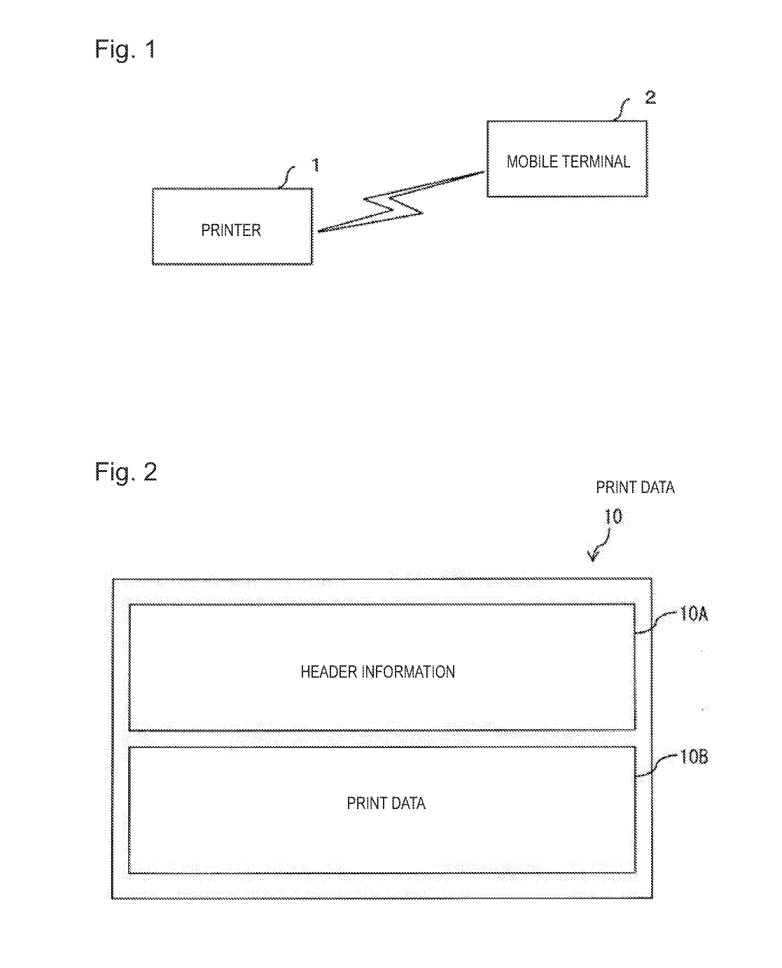

FIG. 1 illustrates a schematic configuration example of the information processing system according to an embodiment of the invention. The information processing system includes printer 1 and mobile terminal 2. Printer 1 corresponds to an example of an image formation apparatus of the invention. Mobile terminal 2 corresponds to an example of an information processing apparatus or an external device of the invention. Printer 1 and mobile terminal 2 are connected to each other through a network. The network is a communication line such as a LAN or WAN. Printer 1 is configured to communicate with mobile terminal 2 through the network. Mobile terminal 2 is configured to communicate with printer 1 through the network.

### Printer 1

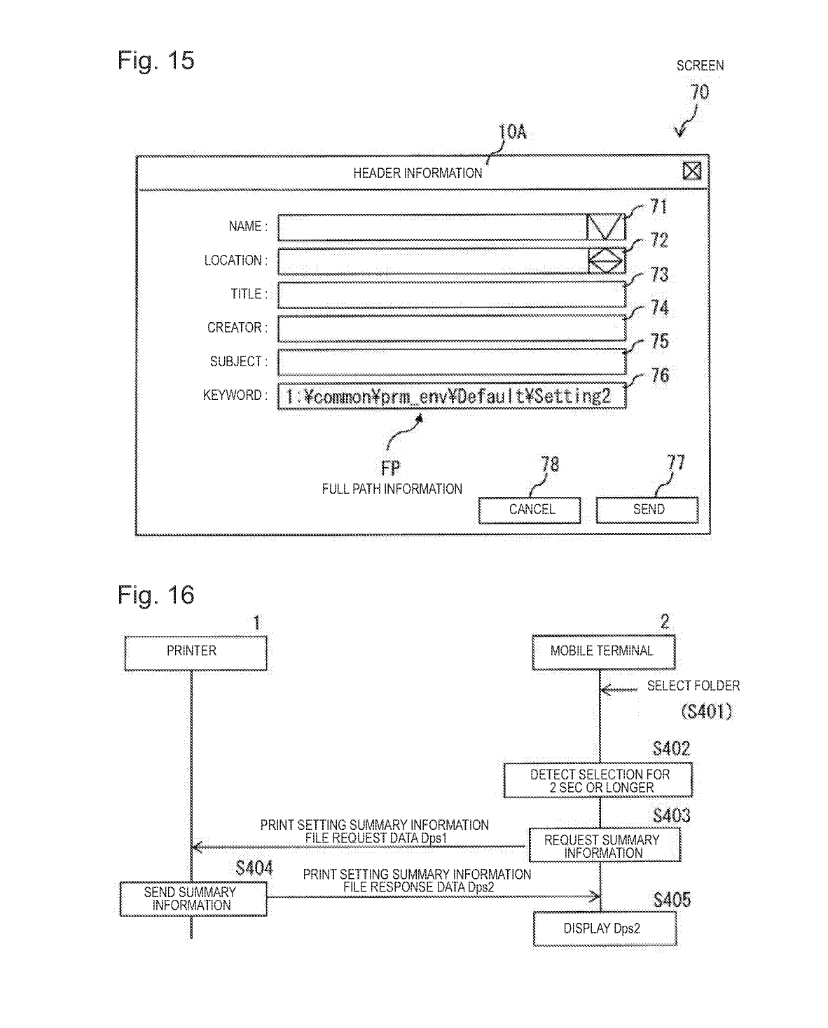

Printer 1 includes a direct printing function of performing a printing based on print data 10 which is not converted to PDL data by a printer driver. Print data 10 includes header information 10A and document information 10B as illustrated in FIG. 2, for example. Header information 10A is information concerning document information 10B to be printed and includes name 71, location 72, title 73, creator 74, subject 75, and keyword 76 as illustrated in FIG. 15 described later, for example. Keyword 76 includes full path (address) information FP of an internal folder of printer 1. Full path information FP corresponds to an example of position information of the invention. Document information 10B includes at least one of text data and photograph data, for example.

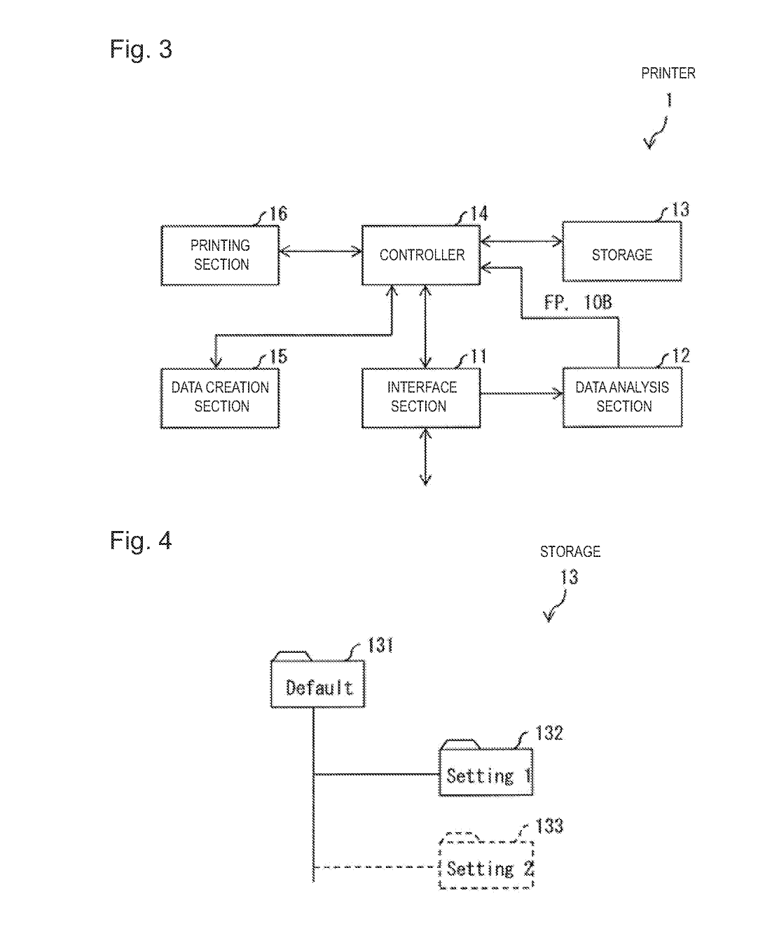

FIG. 3 illustrates a function block example of printer 1 according to this embodiment of the invention. Printer 1 includes interface section 11, data analysis section 12, storage 13, controller 14, data creation section 15, and printing section 16, for example. Storage 13 or memory corresponds to an example of a storage of the invention. Controller 14 corresponds to an example of a first transmission section, a second transmission section, and a creation section of the invention. Printing section 16 corresponds to an example of a printing section of the invention.

Interface section 11 communicates with an external device such as mobile terminal 2. Interface section 11 transfers to controller 14, various request data (later-described connection request data Dc1, for example) received from the external device such as mobile terminal 2. Interface section 11 transmits various response data (later-described connection response data Dc2, for example) to the external terminal such as mobile terminal 2. When receiving print data 10 from the external terminal such as mobile terminal 2, interface section 11 transfers received print data 10 to data analysis section 12.

Data analysis section 12 analyzes whether received print data 10 includes full path (address) information FP. When received print data 10 includes full path (address) information FP, data analysis section 12 extracts full path information FP from print data 10 and outputs extracted full path information FP to controller 14. Data analysis section 12 analyzes whether received print data 10 includes document information 10B. When received print data 10 includes document information 10B, data analysis section 12 extracts document information 10B from print data 10 and outputs extracted document information 10B to controller 14.

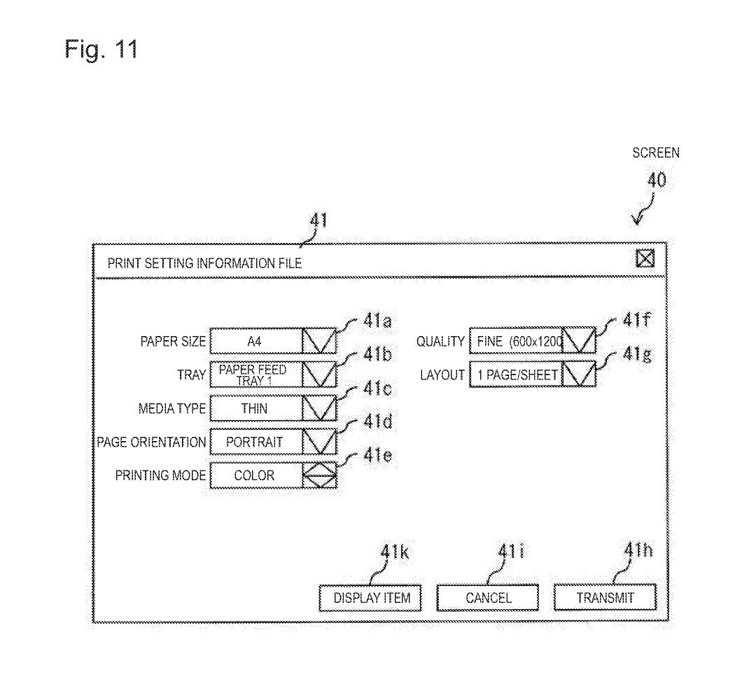

Storage 13 is configured to store print setting information file 41. Storage 13 includes Default folder 131 as illustrated in FIG. 4, for example. Default folder 131 includes Setting1 folder 132. Setting1 folder 132 includes print setting information file 41 previously defined. Storage 13 previously stores print setting information file 41, which is previously included in Setting1 folder 132. Setting1 folder 132 corresponds to an example of a first folder of the invention. Print setting information file 41 previously stored in storage 13 corresponds to an example of initial print setting information of the invention. Print setting information file 41 includes information including paper size 41a, tray 41b, media type 41c, page orientation 41d, printing mode 41e, quality 41f, and layout 41g as illustrated in FIG. 11 described later, for example.

Paper size 41a includes a selection list including A3, A4, A5, B4, and B5, for example, and a paper size selected from the selection list (hereinafter, referred to as selected paper size). The selected paper size is displayed on screen 40 illustrated in FIG. 11. Tray 41b includes a selection list including paper feed tray 1, paper feed tray 2, and a manual feed tray, for example, and a tray selected from the selection list (hereinafter, referred to as a selected tray) . Media type 41c includes a selection list including thick paper, intermediate paper, and thin paper, for example, and a media type selected from the selection list (hereinafter, referred to as a selected media type). Page orientation 41d includes a selection list including portrait and landscape orientations and a page orientation selected from the selection list (hereinafter, referred to as a selected page orientation). Printing mode 41e includes a selection list including black-and-white and color modes and a printing mode selected from the selection list (hereinafter, referred to as a selected printing mode). Quality 41f includes a selection list including standard (600×600 dpi), fine (600×1200 dpi), and superfine (1200×1200 dpi) resolutions and a quality selected from the selection list (hereinafter, referred to as a selected quality). Layout 41g includes a selection list including 1 page/sheet, 2 pages/sheet, and 4 pages/sheet and a layout selected from the selection list (hereinafter, referred to as a selected layout).

Storage 13 further stores information inputted from mobile terminal 2, for example. The information inputted from mobile terminal 2 is information added or edited through an application (print setting utility) of mobile terminal 2 by the user, for example. An example of the information added by the user through the application of mobile terminal 2 is new Setting2 folder 133 illustrated in FIG. 4, for example. Setting2 folder 133 corresponds to an example of a second folder of the invention. In FIG. 4, Setting2 folder 133 is illustrated by dashed lines because Setting2 folder 133 is not stored in storage 13 at the beginning and is added by the user later. Setting2 folder 133 includes print setting information file 41′. As example of the information edited through the application of mobile terminal 2 by the user is print setting information file 41′ included in Setting2 folder 133, for example.

Controller 14 receives various request data from the external device such as mobile terminal 2 (later-described connection request data Dc1, for example) through interface section 11. Controller 14 generates various response data (later-described connection response data Dc2) in accordance with the request from the external device such as mobile terminal 2. Controller 14 sends the generated various response data to the external device, such as mobile terminal 2, through interface section 11.

Controller 14 sends response data including information of print setting information file 41 to the external device such as mobile terminal 2 through interface section 11 according to a request from the external device such as mobile terminal 2. Controller 14 reads print setting information file 41 (print setting information file 41 in Setting1 folder 132, for example) from storage 13 according to a request from the external device such as mobile terminal 2. Controller 14 sends the information of read print setting information file 41 to the external device such as mobile terminal 2 through interface section 11. Controller 14 sends response data including the information of print setting information file 41 (print setting information file 41 in Setting1 folder 132) in storage 13, for example, to the external device such as mobile terminal 2 through interface section 11. Print setting information file 41 in Setting1 folder 132 corresponds to an example of first print setting information of the invention. According to a request from the external device such as mobile terminal 2, controller 14 creates a new folder (Setting2 folder 133, for example) in storage 13 and creates in the new folder created in storage 13 (Setting2 folder 133, for example), print setting information file 41 including the same information as that of print setting information file 41 in Setting1 folder 132. According to a request from the external device such as mobile terminal 2, controller 14 creates tree information TI (described later) concerning the tree structure in storage 13. Controller 14 sends created tree information TI to the external device.

Controller 14 receives the information of print setting information file 41 from the external device such as mobile terminal 2. Print setting information file 41 received from the external device such as mobile terminal 2 includes the same contents as those of print setting information file 41 (Setting1 folder 132 in print setting information file 41, for example) sent to the external device such as mobile terminal 2 or as those of print setting information file 41′ obtained by modifying print setting information file 41. Print setting information file 41 received from the external device such as mobile terminal 2 corresponds to an example of second print setting information of the invention. Controller 14 stores print setting information file 41 received from the external device such as mobile terminal 2 in storage 13. Controller 14 sends to the external device such as mobile terminal 2, full path (address) information FP in storage 13, which indicates print setting information file 41 stored in storage 13.

Controller 14 receives print data 10 from the external device such as mobile terminal 2 through interface section 11. Controller 14 receives full path information FP and document information 10B included in print data 10 through interface section 11 and data analysis section 12, for example. When receiving full path information FP and document information 10B from the external device such as mobile terminal 2, controller 14 reads print setting information file 41 from a folder in storage 13 that corresponds to full path information FP. Controller 14 interprets the format language of document information 10B and rasterizes document information 10B for conversion into data that can be printed by printing section 16. Controller 14 transfers read print setting information file 41 and rasterized document information 10B to printing section 16 and instructs printing section 16 to perform printing based on the transferred data.

When receiving request data Dps1 (described later) through interface section 11, controller 14 reads print setting information file 41 from a folder in storage 13 that corresponds to full path information FP included in received request data Dps1. Controller 14 transfers read print setting information file 41 to data creation section 15 and instructs data creation section 15 to create the summary based on the transferred print setting information file 41. When receiving the summary from data creation section 15, controller 14 outputs the received summary to the external device such as mobile terminal 2 through interface section 11.

Data creation section 15 creates the summary of print setting information file 41 sent from controller 14 and sends the created summary to controller 14. When receiving print data 10 from the external device such as mobile terminal 2, printing section 16 processes received print data 10 based on print setting information file 41 received from the external device such as mobile terminal 2. When being instructed to print by controller 14, printing section 16 prints document information 10B based on rasterized document information 10B and print setting information file 41 stored in storage 13, which corresponds to full path information FP provided from the external device such as mobile terminal 2.

### Mobile Terminal 2

Mobile terminal 2 includes an application program (program 25A) causing mobile terminal 2 to execute a series of operations that cause printer 1 to execute printing using the direct printing function of printer 1. Mobile terminal 2 includes processor 2A which loads program 25A. When program 25A is loaded by processor 2A of mobile terminal 2, processor 2A executes a series of operations described in program 25A.

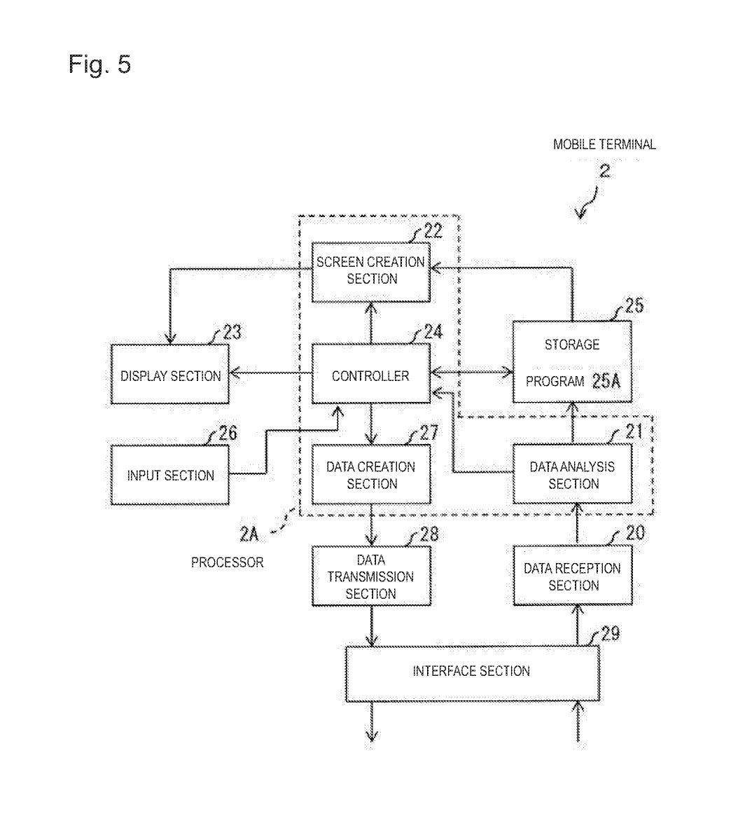

FIG. 5 illustrates a function block example of mobile terminal 2 according to the embodiment of the invention. Mobile terminal 2 includes data analysis section 21, screen creation section 22, display section 23, controller 24, storage 25, input section 26, data creation section 27, data transmission section 28, and interface section 29, for example. Operations performed by data analysis section 21, screen creation section 22, controller 24, and data creation section 27 are executed by processor 2A which has loaded program 25A. Data analysis section 21 and screen creation section 22 correspond to concrete examples of a search section and a first communication section of the invention. Controller 24 and data creation section 27 correspond to a concrete example of a second communication section of the invention. Processor 2A corresponds to an example of the search section, first communication section, and second communication section of the invention.

Input section 26 accepts an input from the user (an instruction to execute, an input of data, or the like, for example). When tree information TI is displayed in display section 23, input section 26 selects any one of the folders and files which are included in tree information TI in accordance with the input from the user, for example. Input section 26 transfers the information inputted by the user to controller 24. Storage 25 stores program 25A and an operating system (OS). Storage 25 stores document information 10B to be printed and various data inputted from data analysis section 21. For example, storage 25 stores connection information of printer 1 (the IP address and name of printer 1, for example), full path information FP used to refer to an internal folder of printer 1, tree information TI in storage 13, and the like. Full path information FP and tree information TI are described later in detail.

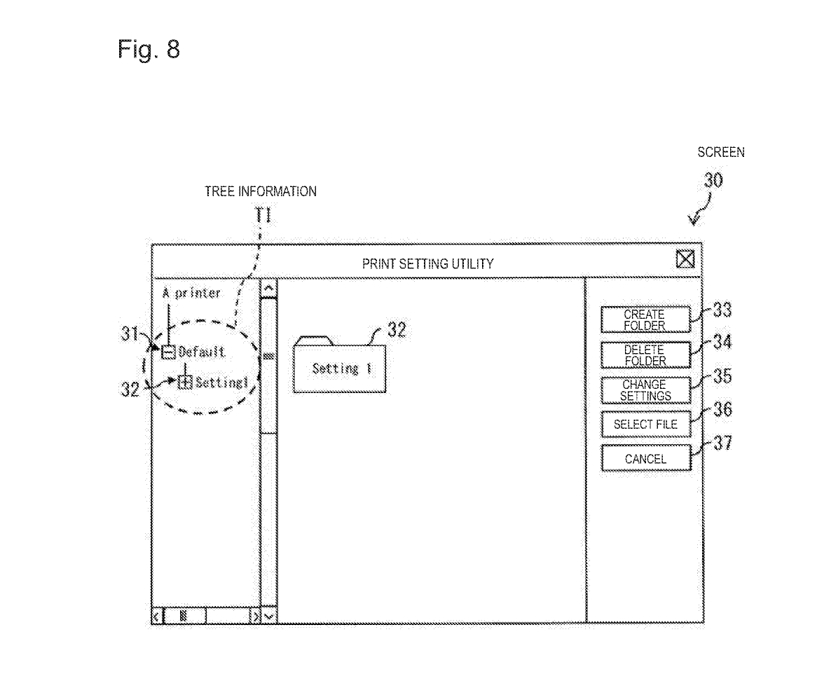

Screen creation section 22 creates data of screens which prompt the user to input information necessary to execute direct printing and prompt the user to confirm the contents in the execution of direct printing. After reading various data from storage 25 at the timing indicated by controller 24, screen creation section 22 creates data of various screens based on the read various data and then sends the created data to display section 23. Screen creation section 22 creates screen data of screen 30 for print setting utility, screen 40 for print setting information file 41, screen 50 for display items 51, screen 60 for header information 61, or the like as illustrated in FIGS. 8 to 12, 14, 15, and 17 described later. Display section 23 performs screen display based on the various screen data (image data of screens 30 to 70, for example) created by screen creation section 22. Display section 23 displays the various screens or stops displaying the various screens at the timing indicated by controller 24.

Controller 24 searches for a printer which can communicate with mobile terminal 2 on the network. Controller 24 gives various instructions to screen creation section 22, display section 23, data creation section 27, and the like based on the information accepted through input section 26 (an instruction to execute, an input of data, or the like for example). Data creation section 27 writes in print data 10, header information 10A including full path (address) information FP of the internal folder of printer 1 and outputs created print data 10 to data transmission section 28. Data creation section 27 creates various request data (later-described connection request data Dc1, for example) and outputs the created request data to data transmission section 28. Data transmission section 28 sends the various request data inputted from data creation section 27 to the printer which can communicate with mobile terminal 2 on the network (printer 1, for example) through interface section 29. The various request data can include print data 10, information of print setting information file 41, or full path information FP, for example. Interface section 29 sends various request data inputted from data transmission section 28 to the printer which can communicate with mobile terminal 2 on the network (printer 1, for example). Interface section 29 receives various response data inputted from the printer that can communicate with mobile terminal 2 on the network and sends the received response data to data reception section 20. The various response data can include tree information TI, information of print setting information file 41, full path information FP, or the summary, for example. Print setting information file 41 which can be included in the response data is print setting information file 41 having the same contents as those of print setting information file 41 (print setting information file 41 in Setting1 folder 132, for example) received from the printer that can communicate with mobile terminal 2 on the network (printer 1, for example) or print setting information file 41′, which is obtained by modifying the above print setting information file 41. The summary that can be included in the response data is the summary of print setting information file 41 stored in storage 13 of the printer (printer 1, for example) capable of communicating on the network, for example. Data reception section 20 acquires various response data through interface section 29 from the printer that can communicate with mobile terminal 2 on the network (printer 1, for example) and outputs the acquired various response data to data analysis section 21. Data analysis section 21 analyzes various data inputted from data reception section 20 and stores the result of the analysis in storage 25.

### Operation

Next, a description is given of an operation procedure of the information processing system. In the following, the operation procedure of the information processing system is described in the order of the following index.
A: Remote connection
B: Print setting information registration
C: Direct printing
D: Summary display

### A: Remote Connection

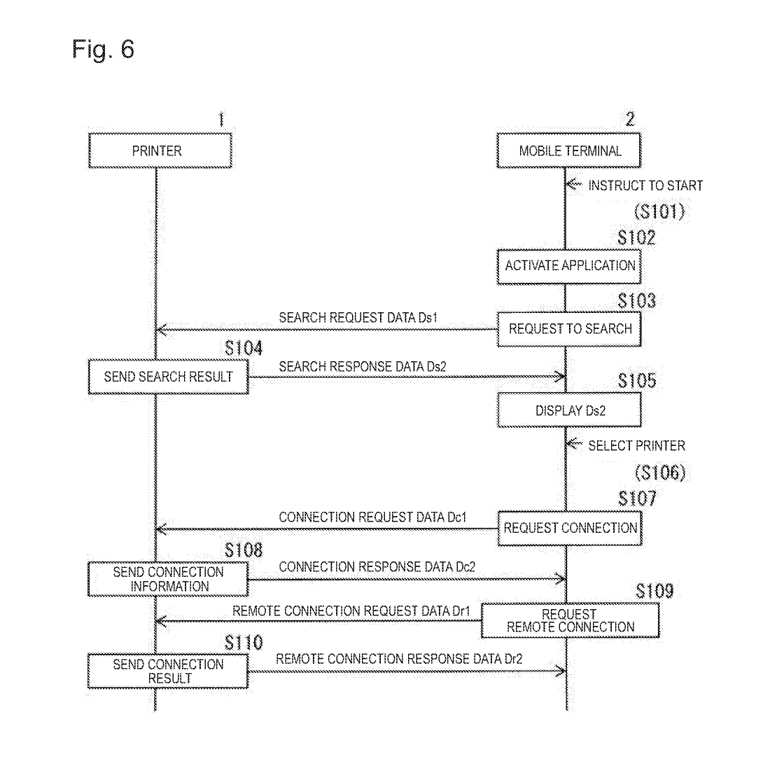

FIG. 6 illustrates an example of the operation procedure of a remote connection in the information processing system. First, the user instructs a start of the application program (program 25A) using input section 26 of mobile terminal 2 (step S101). Processor 2A of mobile terminal 2 loads and activates program 25A stored in storage 25 (step S102). The series of operations executed by processor 2A after program 25A starts are separately described in terms of each operation of controller 24, screen creation section 22, data creation section 27, and data analysis section 21.

Controller 24 requests data creation section 27 to create search request data Ds1 to search for a printer on the network, for example. Data creation section 27 creates search request data Ds1 and sends created search request data Ds1 to data transmission section 28. Data transmission section 28 sends search request data Ds1 inputted from data creation section 27, to the network through interface section 29 by broadcasting (Step S103).

When receiving search request data Ds1 through interface section 11, controller 14 of printer 1 creates search response data Ds2 including connection information of printer 1. The connection information of printer 1 includes the IP address and name of printer 1, for example. Controller 14 sends created search response data Ds2 to mobile terminal 2 on the network through interface section 11 by unicasting (step S104).

When receiving search response data Ds2 through interface section 29, data reception section 20 of mobile terminal 2 sends received search response data Ds2 to data analysis section 21. When receiving search response data Ds2 from data reception section 20, data analysis section 21 analyzes search response data Ds2 and extracts the connection information of printer 1 included in search response data Ds2. Data analysis section 21 stores the extracted connection information of printer 1 in storage 25 and notifies controller 24 that the connection information of printer 1 is stored in storage 25. Upon being notified by data analysis section 21, controller 24 reads the connection information of printer 1 from storage 25. Subsequently, controller 24 requests screen creation section 22 to create data of the connection information screen including the read connection information of printer 1. Screen creation section 22 creates data of the connection information screen and sends the created data to display section 23. Display section 23 performs a screen display based on the data of the connection information screen (step S105).

The user selects printer 1 in the connection information screen of display section 23 by using input section 26 (step S106). Controller 24 then requests data creation section 27 to create connection request data Dc1 for a connection to printer 1 received from input section 26. Data creation section 27 creates connection request data Dc1 and sends the created connection request data Dc1 to data transmission section 28. Data transmission section 28 sends connection request data Dc1 sent from data creation section 27, to printer 1 on the network through interface section 29 by unicasting (step S107).

When receiving connection request data Dc1 through interface section 11, controller 14 of printer 1 creates connection response data Dc2 including full path information FP used to refer to an internal folder (specifically, Setting1 folder 132 in storage 13) of printer 1. Controller 14 sends created connection response data Dc2 through interface section 11 to mobile terminal 2 on the network by unicasting (step S108).

When receiving connection response data Dc2 through interface section 29, data reception section 20 of mobile terminal 2 sends received connection response data Dc2 to data analysis section 21. When receiving connection response data Dc2 from data reception section 20, data analysis section 21 analyzes connection response data Dc2 and extracts full path information FP included in connection response data Dc2. Data analysis section 21 stores the extracted full path information FP in storage 25 and notifies controller 24 that full path information FP is stored in storage 25. Upon being notified by data analysis section 21, controller 24 reads the full path information and the connection information for printer 1 (the IP address, for example) from storage 25. Subsequently, controller 24 sends read full path information FP and the connection information of printer 1 to data creation section 27 and requests data creation section 27 to create remote connection request data Dr1 to make a remote connection request to printer 1. Data creation section 27 creates remote connection request data Dr1 including full path information FP and the connection information of printer 1 which are inputted from controller 24 and sends created remote connection request data Dr1 to data transmission section 28. Data transmission section 28 sends remote connection request data Dr1 inputted from data creation section 27, through interface section 29 to printer 1 on the network by unicasting (Step S109).

When receiving remote connection request data Dr1 through interface section 11, controller 14 of printer 1 creates remote connection response data Dc2 including full path information FP to refer to the internal folder of printer 1 (specifically, Setting1 folder 132 in storage 13). Controller 14 sends created remote connection response data Dc2 through interface section 11 to mobile terminal 2 on the network by unicasting (step S110). Controller 14 of printer 1 checks the security of mobile terminal 2 through a password or the like and starts the remote connection with mobile terminal 2. When receiving a remote connection request from a different mobile terminal while being remotely connected with mobile terminal 2, for example, controller 14 of printer 1 sends a response indicating that printer 1 is remotely connected to mobile terminal 2, by unicasting to the different mobile terminal having sent the request.

### B: Print Setting Information Registration

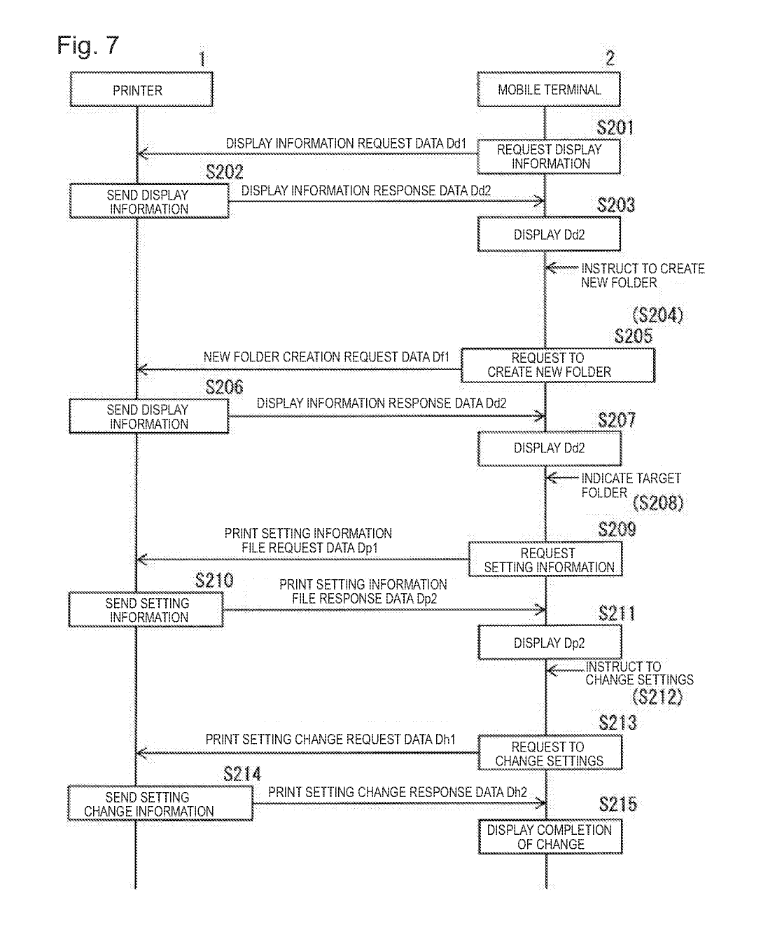

FIG. 7 illustrates an example of the operation procedure of print setting information registration in the information processing system. After the remote connection between printer 1 and mobile terminal 2 is started, controller 24 of mobile terminal 2 requests data creation section 27 to create display information request data (request data Dd1) to acquire tree information TI in storage 13 of printer 1. Tree information TI is information concerning the tree structure of folders and files in storage 13 of printer 1. Tree information TI includes information of at least either a folder or a file in storage 13 of printer 1. Upon being instructed to create request data Dd1, data creation section 27 creates request data Dd1 and sends the created request data Dd1 to data transmission section 28. Data transmission section 28 sends request data Dd1 received from data creation section 27, through interface section 29 to printer 1 on the network by unicasting (step S201).

When receiving request data Dd1 through interface section 11, controller 14 of printer 1 creates tree information TI in storage 13 of printer 1 and creates display information response data (response data Dd2) including created tree information TI. Controller 14 sends created response data Dd2 to mobile terminal 2 on the network through interface section 11 by unicasting (step S202).

When receiving response data Dd2 including tree information TI through interface section 29, data reception section 20 of mobile terminal 2 sends received response data Dd2 to data analysis section 21. When receiving response data Dd2 from data reception section 20, data analysis section 21 analyzes response data Dd2 and extracts tree information TI included in response data Dd2. Data analysis section 21 stores extracted tree information TI in storage 25 and notifies controller 24 that tree information TI is stored in storage 25. Upon being notified by data analysis section 21, controller 24 reads tree information TI from storage 25. Subsequently, controller 24 sends read tree information TI to screen creation section 22 and requests screen creation section 22 to create data of the print setting utility screen including tree information TI. Screen creation section 22 creates data of the print setting utility screen and sends the created data to display section 23. Display section 23 displays the screen (screen 30) based on the data of the print setting utility screen (step S203).

FIG. 8 illustrates an example of screen 30. In the left part of screen 30, the tree structure (tree information TI) in storage 13 of printer 1 is graphically displayed. The tree structure in storage 13 of printer 1 has a structure in which Setting1 folder 32 is stored in Default folder 31 as illustrated in FIG. 8, for example. In the center part of screen 30, Setting1 folder 32 included in storage 13 of printer 1 is graphically displayed. In the right part of screen 30, various command buttons which can be operated by the user are graphically displayed. The various command buttons include create folder 33, delete folder 34, change settings 35, select file 36, and cancel 37, for example.

Herein, it is assumed that document information 10B to be printed is stored in storage 25. In order to perform a direct printing of document information 10B stored in storage 25 with printer 1, the user configures print setting information file 41 for document information 10B in printer 1. In this embodiment, to configure print setting information file 41 for document information 10B in printer 1, it is necessary to create a folder for document information 10B in Default folder 131 in storage 13 of printer 1 and set print setting information file 41 for document information 10B in the created folder for document information 10B.

First, the user creates a new folder within storage 13 of printer 1, for example. In this process, the user uses input section 26 to select any one of the folders and files (Setting1 folder 132, for example) included in tree information TI in screen 30 of display section 23. Next, the user selects create folder 33 with Setting1 folder 132 selected (Step S204). Controller 24 then requests data creation section 27 to create a new folder creation request data (request data Df1) to make a request to create a new folder that is inputted from input section 26. Data creation section 27 creates request data Df1 and sends created request data Df1 to data transmission section 28. Data transmission section 28 sends request data Df1 received from data creation section 27, to printer 1 on the network through interface section 29 by unicasting (Step S205).

When receiving request data Df1 through interface section 29, controller 14 of printer 1 creates print setting information file 41 including the same information as that of print setting information file 41 included in Setting1 folder 32 and stores created print setting information file 41 in storage 13. When receiving request data Df1 through interface section 11, controller 14 creates New folder 38a in Default folder 31. In this process, controller 14 creates in New folder 38a, print setting information file 41 including the same information as that of print setting information file 41 included in Setting1 folder 32. Controller 14 creates tree information TI including created New folder 38a and creates display information response data (response data Dd2) including tree information TI. Controller 14 sends created response data Dd2 to mobile terminal 2 on the network through interface section 11 (step S206).

When receiving response data Dd2 through interface section 29, data reception section 20 of mobile terminal 2 sends received response data Dd2 to data analysis section 21. When receiving response data Dd2 from data reception section 20, data analysis section 21 analyzes response data Dd2 and extracts tree information TI included in response data Dd2. Tree information TI includes information concerning New folder 38a. Data analysis section 21 stores extracted tree information TI in storage 25. In this process, when tree information TI is already stored in storage 25, data analysis section 21 writes new information (tree information TI extracted from response data Dd2) over old information (tree information TI already stored in storage 25), for example.

Data analysis section 21 notifies controller 24 that tree information TI is stored in storage 25. Upon being notified by data analysis section 21, controller 24 reads tree information TI from storage 25. Subsequently, controller 24 sends read tree information TI to screen creation section 22 and requests screen creation section 22 to create data of the print setting utility screen including tree information TI. Screen creation section 22 creates data of the print setting utility screen and sends the created data to display section 23. Display section 23 displays the screen (screen 30) based on the data of the print setting utility screen (Step S207).

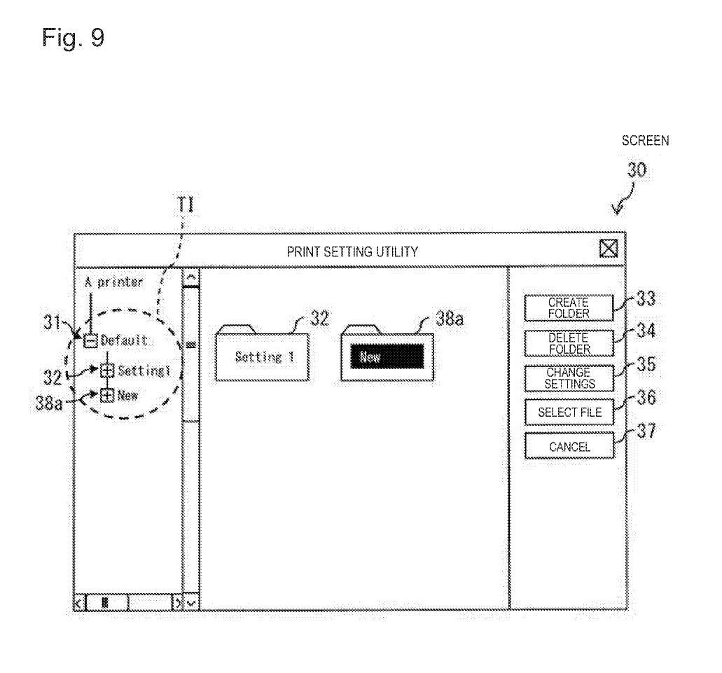

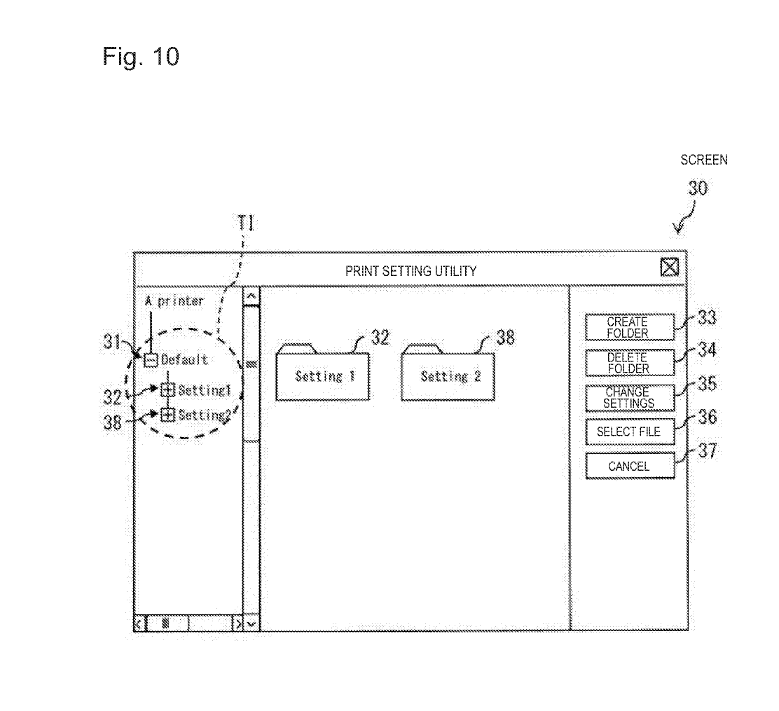

FIG. 9 illustrates an example of screen 30 in this process. In the left and center parts of screen 30, New folder 38a added to storage 13 of printer 1 is displayed. In this process, New folder 38a is displayed with the black and white colors reversed. This is to prompt the user to change the name of New folder 38a. The user can change the name of New folder 38a using input section 26. When the user changes the name of New folder 38a to Setting2, New folder 38a in screen 30 is changed to Setting2 as illustrated in FIG. 10, for example. Hereinafter, the operation procedure is described by assuming that the user has changed the name of New folder 38a to Setting2.

Subsequently, the user changes print setting information file 41 in Setting2 folder 38, for example. In this process, the user selects setting change 35 for setting2 folder 38 in screen 30 of display section 23 using input section 26 with Setting2 folder 38 selected (Step S208). Controller 24 requests data creation section 27 to create print setting information file request data (request data Dp1) to make a request to change the settings of Setting2 folder 38 which is inputted from input section 26. Data creation section 27 then creates request data Dp1 and sends created request data Dp1 to data transmission section 28. Data transmission section 28 sends request data Dp1, received from data creation section 27, to printer 1 on the network through interface section 29 by unicasting (step S209).

When receiving request data Dp1 through interface section 11, controller 14 of printer 1 creates print setting information file response data (response data Dp2) including the information of print setting information file 41 included in Setting2 folder 38. Controller 14 sends created response data Dp2 to mobile terminal 2 on the network through interface section 11 by unicasting (step S210).

When receiving response data Dp2 through interface section 29, data reception section 20 of mobile terminal 2 sends received response data Dp2 to data analysis section 21. When receiving response data Dp2 from data reception section 20, data analysis section 21 analyzes response data Dp2 and extracts from response data Dp2, information of print setting information file 41 included in Setting2 folder 38. Data analysis section 21 stores the extracted information of print setting information file 41 in storage 25. In this process, when print setting information file 41 of Setting2 folder 38 is already stored in storage 25, data analysis section 21 writes new information (information of print setting information file 41 extracted from response data Dp2) over old information (information of print setting information file 41 already stored in storage 25), for example.

Data analysis section 21 notifies controller 24 that print setting information file 41 is stored in storage 25. Upon being notified by data analysis section 21, controller 24 reads print setting information file 41 of Setting2 folder 38 from storage 25. Subsequently, controller 24 requests screen creation section 22 to create data of the change settings screen including read print setting information file 41 of Setting2 folder 38. Screen creation section 22 then creates data of the change settings screen and sends the created data to display section 23. Display section 23 displays the screen (screen 40) based on the data of the change settings screen (step S211).

FIG. 11 illustrates an example of screen 40. In the center part of screen 40, setting items included in print setting information file 41 of Setting2 folder 38 are graphically displayed. For example, at one of the setting items included in print setting information file 41, “selected paper size” is displayed on screen 40. At the bottom of screen 40, various command buttons that can be operated by the user are graphically displayed. The various command buttons include send 41h, cancel 41i, and display item 41k, for example.

It is assumed that the user selects display item 41k at the bottom of screen 40 using input section 26. Controller 24 then requests screen creation section 22 to create screen data for displaying display items 41k. In accordance with the request from controller 24, screen creation section 22 creates screen data for displaying display items and sends the created data to display section 23. Display section 23 displays the screen (screen 50) based on the screen data for displaying display items 41k.

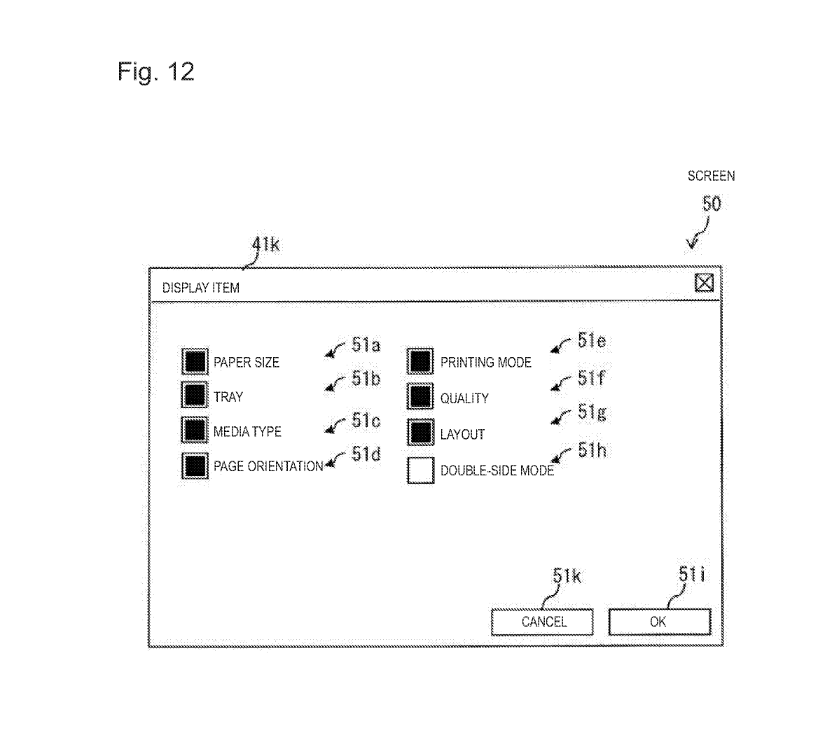

FIG. 12 illustrates an example of screen 50. In the center of screen 50, a list of display items 41k is graphically displayed. The list of display items 41k includes paper size 51a, tray 51b, media type 51c, page orientation 51d, printing mode 51e, quality 51f, layout 51g, and double-side printing 51h, for example. In the list of display items 41k, checkboxes that the user can check are provided. At the bottom of the screen 50, various command buttons that can be operated by the user are graphically displayed. The various command buttons include OK 51i and cancel 51k, for example.

Using input section 26, the user changes the display items to be displayed in screen 40 and selects OK 51i if necessary. Controller 24 then requests screen creation section 22 to change the data of the change settings screen in accordance with an instruction to change the display items that is inputted from input section 26. Screen creation section 22 changes the data of the change settings screen in accordance with the request from controller 24 and sends the changed data of the change settings screen to display section 23. Display section 23 displays the screen based on the change data of the change settings screen.

Using input section 26, the user changes print setting information file 41. When the user changes the paper size to B5 by using input section 26, for example, controller 24 stores in storage 25, information (B5) of the paper size inputted from input section 26 as the selected paper size. The user then selects transmission 41h using input section 26 (step S212). Controller 24 thereby requests data creation section 27 to create print setting change request data (request data Dh1) to make a request to change print setting information file 41 of Setting2 folder 38 that is inputted from input section 26. Data creation section 27 then creates request data Dh1 including information of new print setting information file 41′ and sends created request data Dh1 to data transmission section 28. Data creation section 27, for example, reads new print setting information file 41′ from storage 25, creates request data Dh1 including the read information of new print setting information file 41′, and sends created request data Dh1 to data transmission section 28. Data transmission section 28 sends request data Dh1 received from data creation section 27, to printer 1 on the network through interface section 29 by unicasting (step S213).

When receiving request data Dh1 through interface section 11, controller 14 of printer 1 stores in storage 13, the information of new print setting information file 41′ included in request data Dh1. When receiving request data Dh1 through interface section 11, controller 14 of printer 1 replaces the print setting information file 41 included in Setting2 folder 38 with print setting information file 41′ included in request data Dh1. When the user has changed print setting information file 41 in screen 40, the contents of print setting information file 41′ included in request data Dh1 are information obtained by modifying print setting information file 41 within Setting2 folder 38 (that is, print setting information file 41 of Setting2 folder 38 included in response data Dp2). When the user has not changed print setting information file 41 in screen 40, the contents of print setting information file 41 included in request data Dh1 are information having the same contents as those of print setting information file 41 within Setting2 folder 38 (that is, print setting information file 41 of Setting2 folder 38 included in response data Dp2) . After the above replacement, controller 14 reads print setting information file 41′ from Setting2 folder 38. Subsequently, controller 14 creates print setting change response data (response data Dh2) including the information of read print setting information file 41′ of Setting2 folder 38 and full path information FP to refer to read Setting2 folder 38. Controller 14 sends created response data Dh2 to mobile terminal 2 on the network through interface section 11 by unicasting (step S214).

When receiving response data Dh2 through interface section 29, data reception section 20 of mobile terminal 2 sends received response data Dh2 to data analysis section 21. When receiving response data Dh2 from data reception section 20, data analysis section 21 analyzes response data Dh2 and extracts the information of print setting information file 41′ of Setting2 folder 38 included in response data Dh2. Data analysis section 21 extracts full path information FP to refer to Setting2 folder 38, which is included in response data Dh2. Data analysis section 21 stores information of extracted print setting information file 41′ and full path information FP in storage 25. When print setting information file 41′ of Setting2 folder 38 and full path information FP are already stored in storage 25 in this process, data analysis section 21 writes the new information (print setting information file 41′ and full path information FP extracted from response data Dh2) over the old information (print setting information file 41′ and full path information FP already stored in storage 25), for example.

Data analysis section 21 notifies controller 24 that print setting information file 41′ is stored in storage 25. Upon being notified from data analysis section 21, controller 24 requests screen creation section 22 to create data of a screen (a superimposed screen) in which a display is superimposed on screen 30 indicating the completion of the change of print setting information file 41′ of the Setting2 folder 38. Screen creation section 22 then creates the data of the superimposed screen and sends the created data to display section 23. Display section 23 indicates on screen 30 the completion of the change of print setting information file 41′ of Setting2 folder 38 (step S215).

When the user after selecting folder creation 30 selects select file 36 in screen 30 instead of setting change 35, controller 24 may request screen creation section 22 to create screen data (a superimposed screen) in which a notification that there are two folders including identical print setting information files 41 is superimposed on screen 30. In this case, screen creation section 22 creates data of the superimposed screen and sends the created data to display section 23. Display section 23 shows in screen 30 that there are two folders containing identical print setting information files 41.

### C: Direct Printing

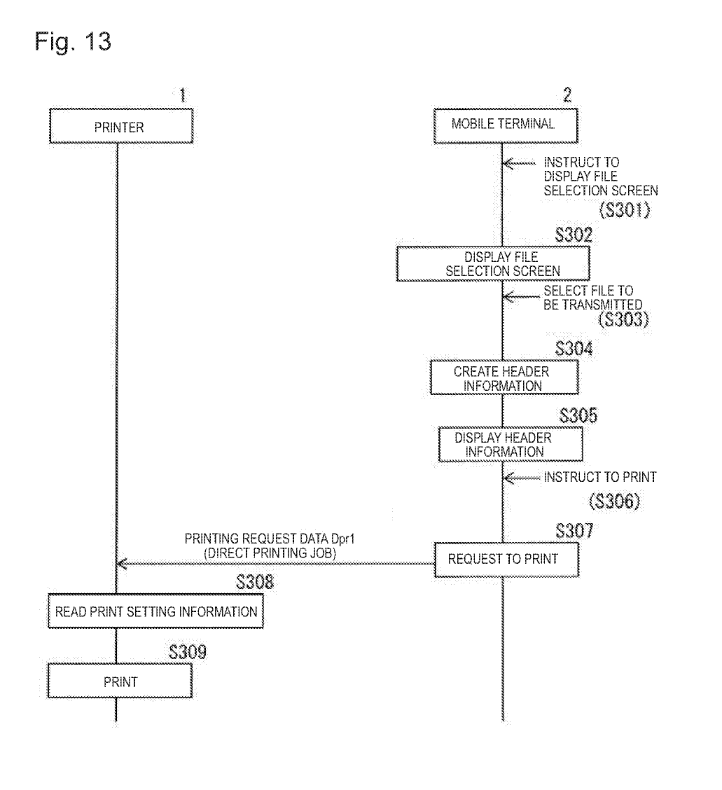

FIG. 13 illustrates an example of the operation procedure of printing in the information processing system. First, using input section 26 of mobile terminal 2, the user selects Setting2 folder 38 and then selects select file 36 in screen 30 of FIG. 10 (step S301). Controller 24 thereby requests data creation section 27 to create data of the file selection screen. Data creation section 27 creates the data of the file selection screen and sends the created data to display section 23. Display section 23 displays the screen (screen 60) based on the data of the file selection screen (step S302).

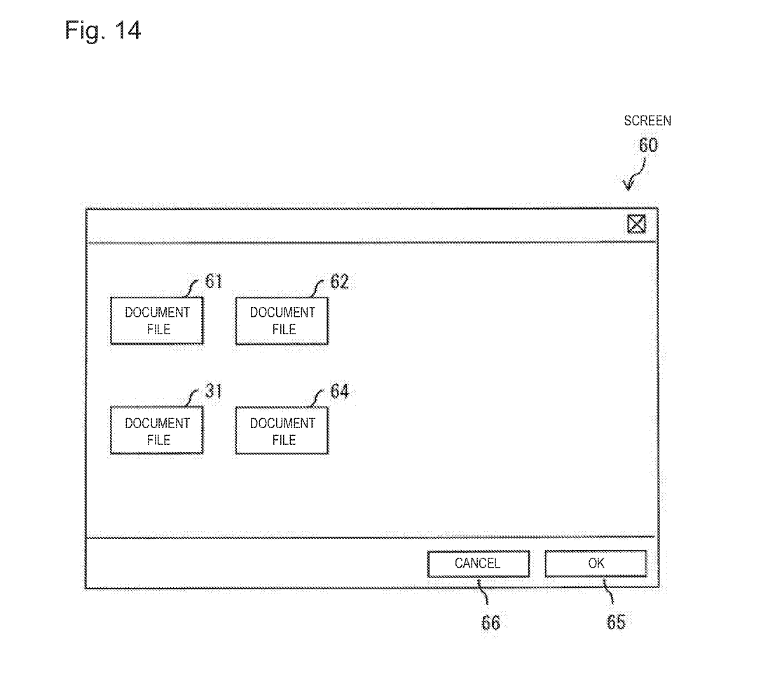

FIG. 14 illustrates an example of screen 60. In the center part of screen 60, document files 61 to 64 stored in storage 25 of mobile terminal 2 are graphically displayed. Each of document files 61 to 64 includes at least any one of a text and a photograph, for example. Using input section 26 of mobile terminal 2, the user selects one document file (document file 61, for example) and then selects OK 65 (step S303). Controller 24 thereby specifies the document file to be transmitted based on the information inputted from input section 26 and sets the specified document file as document information 10B of print data 10. Controller 24 reads full path information FP for Setting2 folder 38 from storage 25 and creates header information 10A including read full path information FP (step S304).

Controller 24 then sends header information 10A to screen creation section 22 and requests screen creation section 22 to create data of the header information screen including header information 10A. Screen creation section 22 then creates the data of the header information screen and sends the created data to display section 23. Display section 23 displays a screen (screen 70) based on the data of the header information screen (step S305).

FIG. 15 illustrates an example of screen 70. In the center part of screen 70, a list of header information 10A is graphically displayed. At the bottom of screen 70, various command buttons that can be operated by the user are graphically displayed. The various command buttons include send 77 and cancel 78, for example. In the list of header information 10A, full path information FP read from storage 25 is displayed in the field of keyword 76. The user can add or modify header information 10A using input section 26 if necessary.

Next, when the user selects transmission 77 in screen 70 using input section 26 (step S306), controller 24 writes header information 10A in print data 10. Controller 24 requests data creation section 27 to create printing request data (request data Dpr1) to make a printing request that is inputted from input section 26. Data creation section 27 creates request data Dpr1 including print data 10 and sends created request data Dpr1 to data transmission section 28. Data transmission section 28 outputs request data Dpr1 from data creation section 27 as a direct printing job through interface section 29 (step S307). Data transmission section 28 sends request data Dpr1 to printer 1 on the network by unicasting.

When receiving request data Dpr1 through interface section 11, data analysis section 12 of printer 1 extracts print data 10 from received request data Dpr1. Data analysis section 12 reads full path information FP from header information 10A of extracted print data 10 and sends read full path information FP to controller 14. Controller 14 reads from storage 13, print setting information file 41 corresponding to full path information FP inputted from data analysis section 12 (step S308). Data analysis section 12 further extracts document information 10B from print data 10 and sends extracted document information 10B to controller 14. Controller 14 rasterizes and converts document information 10B inputted from data analysis section 12 into data that can be printed by printing section 16. Thereafter, controller 14 transfers the read print setting information file 41 and rasterized document information 10B to printing section 16 and instructs printing section 16 to print based on the transferred data. Upon being instructed by the controller 14 to print, printing section 16 prints document information 10 based on rasterized document information 10B and print setting information file 41 in storage 13 corresponding to full path information FP provided from the external device such as mobile terminal 2 (step S309). Direct printing is thus carried out.

### D: Summary Display

FIG. 16 illustrates an example of the operation procedure of the summary display in the information processing system. For example, it is assumed that the user selects Setting2 folder 38 in screen 30 of FIG. 10 (step S401). When a detector of mobile terminal 2 detects that Setting2 folder 38 has been selected for a predetermined number of seconds (two seconds, for example) or longer (step S402), the detector notifies controller 24 that Setting2 folder 38 has been selected for the predetermined number of seconds (two seconds, for example) or more.

Upon being notified by the detector, controller 24 reads full path information FP stored in storage 25. The read full path information FP is full path information used to refer to the folder which is being selected (Setting2 folder 38). Controller 24 requests data creation section 27 to create print setting summary information file request data (request data Dps1). The request data Dps1 is to display as a tool chip, the summary of print setting information file 41 in the folder which is being selected (Setting2 folder 38). Data creation section 27 then creates request data Dps1 including the read full path information FP and sends created request data Dps1 to data transmission section 28. Data transmission section 28 sends request data Dps1 from data creation section 27, to printer 1 on the network through interface section 29 by unicasting (step S403).

When receiving request data Dps1 through interface section 11, controller 14 of printer 1 notifies data creation section 15 that request data Dps1 is received. Controller 14 then extracts full path information FP included in request data Dps1 and reads print setting information file 41 in the folder corresponding to the extracted full path information FP. Controller 14 sends the now read print setting information file 41 to data creation section 15. Data creation section 15 analyzes print setting information file 41 inputted from controller 14 to create summary information. Data creation section 15 creates the summary information by extracting the selected paper size or the like included in print setting information file 41, for example. Data creation section 15 then creates print setting summary information file response data (response data Dps2) including the summary information. Data creation section 15 sends created response data Dps2 to controller 14. Controller 14 sends response data Dps2 inputted from data creation section 15, through interface section 11 to mobile terminal 2 on the network by unicasting (step S402).

When receiving response data Dps2 through interface section 29, data reception section 20 of mobile terminal 2 sends received response data Dps2 to data analysis section 21. When receiving response data Dps2 from data reception section 20, data analysis section 21 analyzes response data Dps2 and extracts the summary information of Setting2 folder 38 included in response data Dps2. Data analysis section 21 stores the extracted summary information in storage 25 and notifies controller 24 that the summary information is stored in storage 25. Upon being notified by data analysis section 21, controller 24 reads the summary information from storage 25. Subsequently, controller 24 requests screen creation section 22 to create screen data (a superimposed screen) in which an indication of the read summary information is superimposed on screen 30. Screen creation section 22 creates the data of the superimposed screen and sends the created data to display section 23. Display section 23 displays the summary information of Setting2 folder 38 on screen 30 (step S405).

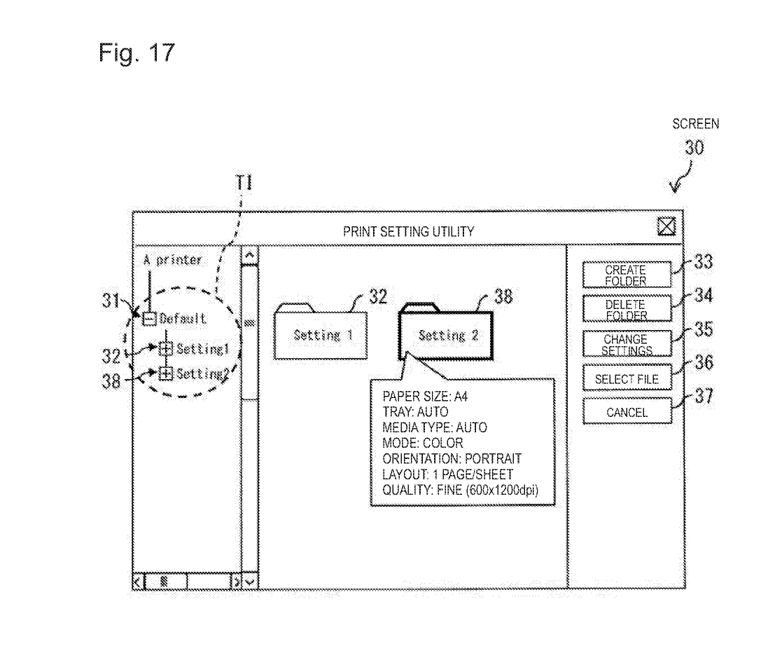

FIG. 17 illustrates an example of screen 30 in this process. In the center part of screen 30, Setting2 folder 38 is highlighted. Highlighted Setting2 folder 38 is accompanied with a caption, which shows the summary information of Setting2 folder 38. In screen 30 of FIG. 10, when the detector of mobile terminal 2 detects that Setting1 folder 32 has been selected for the predetermined number of seconds (two seconds, for example) or more, the summary information of Setting1 folder 32 is displayed.

### Effect

Next, the effects of the information processing system of the specification are described.

In normal direct printing in which a file is directly transferred to a printer to be printed without being converted to PDL data by a printer driver, it is difficult to make print settings on a file-by-file basis because the printer driver is not used.

In the information processing system of the specification, the user can obtain initial data of print setting information file 41 necessary for printing from printer 1 by operating mobile terminal 2. Accordingly, the user changes the initial data of print setting information file 41 acquired from printer 1 to setting information necessary for the printing of document information 10B and then stores new print setting information file 41 in printer 1. In the information processing system of the specification, the user can easily notify printer 1 of the setting information necessary for the printing of document information 10B even when mobile terminal 2 does not include a driver for printer 1. Accordingly, the user can easily configure the print settings for each piece of document information 10B in direct printing.

Moreover, in the information processing system of the specification, the user acquires address information FP of print setting information file 41 stored in printer 1 from printer 1 by operating mobile terminal 2. Accordingly, the user can notify printer 1 of the location of the setting information necessary for the printing of document information 10B only by sending address information FP acquired from printer 1 together with document information 10B in the process of sending a printing job from mobile terminal 2 to printer 1. The user can therefore easily configure the print settings for each piece of document information 10B in direct printing.

In the information processing system of the specification, in accordance with the request of mobile terminal 2, print setting information file 41 including the same information as that of print setting information file 41 in the Setting1 folder 132 is stored in Setting2 folder 133. Accordingly, the setting information necessary for the printing of document information 10B can be provided for each piece of document information 10B. The user can therefore easily configure the print settings for each piece of document information 10B in direct printing. In the information processing system of the specification, in accordance with the request of mobile terminal 2, tree information TI concerning the tree structure in storage 13 is created and transmitted to mobile terminal 2. The user therefore can configure the setting information necessary for the printing of document information 10B for each piece of document information 10B while checking tree information TI. Accordingly, the user can easily configure the print settings for each piece of document information 10B in direct printing.

Furthermore, in the information processing system of the specification, in accordance with the request of mobile terminal 2, the summary of print setting information file 41 read from storage 13 is transmitted to mobile terminal 2. The user therefore configures the setting information necessary for the printing of document information 10B for each piece of document information 10B while checking the summary of print setting information file 41. Accordingly, the user can easily configure the print settings for each piece of document information 10B in direct printing.

### 2. Modifications

Hereinafter, a description is given of modifications of the information processing system of the embodiment. In the following description, the same constituent components as those of the embodiment are given the same reference numerals as those given to the embodiment. The description is mainly given of the components that are different from those of the embodiment, and the same constituent components as those of the embodiment are not described if unnecessary.

### Modification 1

In the embodiment, printer 1 and mobile terminal 2 may be serially connected to each other by USB connectors or the like, for example.

### Modification 2

In the embodiment and modifications thereof, printer 1 may be shared by plural mobile terminals 2 on the network. In this case, the request to change the print settings (request data Dh1) can be transmitted from each mobile terminal 2. Accordingly, controller 14 of printer 1 may add to the property of a new folder created in storage 13, information concerning mobile terminal 2 which has made the request to create the folder. In other words, storage 13 may include a personal folder including print setting information file 41.

Herein, mobile terminal 2 which has made the request to change the settings (request data Dh1) for printer 1 is referred to as mobile terminal 2a. When receiving a request to change the print settings (request data Dh1) from certain mobile terminal 2a, controller 14 of printer 1 extracts from the property of the folder in which the print settings are to be changed (hereinafter, referred to as a target folder), information concerning mobile terminal 2 having made a request to create the folder. As the result, controller 14 of printer 1 permits mobile terminal 2a, which has made the request to change the print settings (request data Dh1), to access the target folder only when mobile terminal 2 acquired by the extraction matches mobile terminal 2a which has made the request to change the print settings (request data Dh1).

When a folder is newly created in storage 13, controller 14 of printer 1 may add a flag to permit a sharing of the property of the created folder. In other words, storage 13 may include a shared folder including print setting information file 41. In this case, when receiving a request to change the print settings (request data Dh1) from a certain mobile terminal 2a, controller 14 of printer 1 may permit mobile terminal 2a, having made the request to change the print settings (request data Dh1), to access the target folder even when mobile terminal 2 extracted from the property of the target folder does not match mobile terminal 2a which has made the request to change the print settings (request data Dh1).

### Modification 3

The aforementioned embodiment and modifications exemplify direct printing through communication between mobile terminal 2 and printer 1. However, in the aforementioned embodiment and modifications, mobile terminal 2 may be replaced with an information processing apparatus (personal computer (PC), for example) other than mobile terminal 2. In this case, the information processing device includes the elements necessary for carrying out direct printing among the elements included in printer 1.

### Modification 4

In the aforementioned embodiment and modifications, direct printing through communication between mobile terminal 2 and printer 1 is exemplified. However, in the aforementioned embodiment and modifications, printer 1 may be replaced with a facsimile or a scanner. In this case, the facsimile or scanner includes the elements necessary for carrying out direct printing among the elements included in printer 1.

### Modification 5

In the aforementioned embodiment and modifications, storage 13 includes one (Setting1 folder 132, for example) or plural folders (Setting1 folder 132 and Setting2 folder 133) in Default folder 131. However, in the aforementioned embodiment and modifications, storage 13 may include print setting information file 41 in Default folder 131 without Setting1 folder 132. Moreover, in the aforementioned embodiment and modifications, storage 13 may include print setting information file 41 in Default folder 131 without Setting2 folder 133. In this case, printer 1 includes any means to identify each print setting information file 41 included in Default folder 131.

### Modification 6

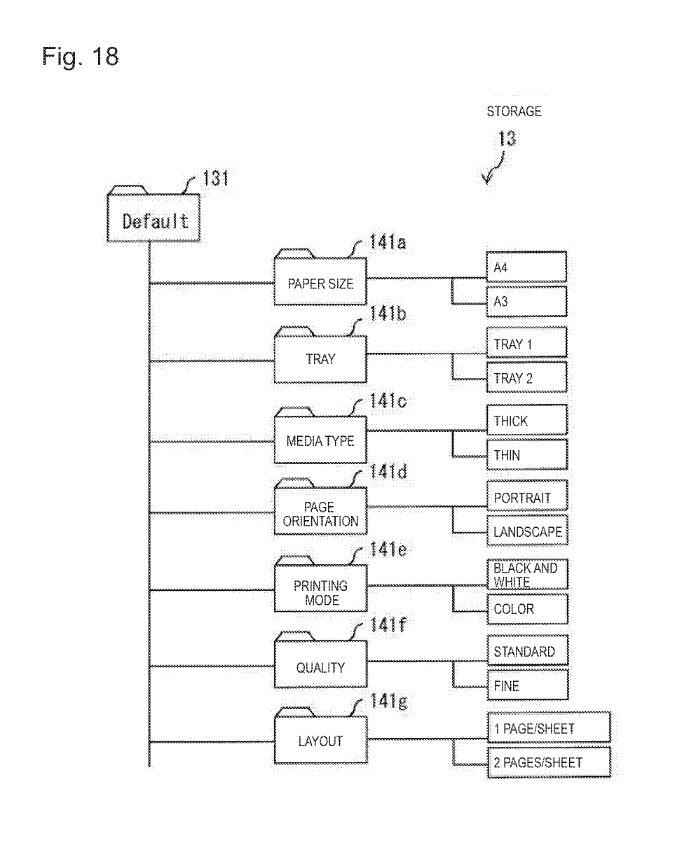

In the aforementioned embodiment and modifications, controller 14 of printer 1 creates a folder in storage 13 each time controller 14 newly creates print setting information file 41 according to a request from the external device such as mobile terminal 2. However, in the aforementioned embodiment and modifications, storage 13 may include a folder for each print setting item of print setting information file 41 previously configured (initial print setting information). In that case, each time controller 14 newly creates print setting information file 41 in accordance with the request from the external device such as mobile terminal 2, controller 14 may separately create print setting information file 41 in the folders of storage 13 in terms of the print setting items of the print setting information file 41. As illustrated in FIG. 18, for example, storage 13 includes in Default folder 131, folders for the respective print setting items (paper size 41a, for example) of print setting information file 41. The plural folders provided for the respective print setting items of print setting information in Default folder 131 are paper size 141a, tray 141b, media type 141c, page orientation 141d, printing mode 141e, quality 141f, and layout 141g as illustrated in FIG. 18, for example. In this case, full path information FP includes full path information of each folder in Default folder 131.

### Modification 7

The series of processes described in the aforementioned embodiment and modifications may be implemented by either hardware (circuits) or software (programs). When the series of processes are implemented by software, the software is composed of a group of programs causing a computer to execute each function. Each program may be previously built in the computer or may be installed in the computer through a network or a recording medium, for example.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. An image formation apparatus, comprising:
a first transmission section that sends a first print setting information to an external device according to a request from the external device;
a first reception section that receives second print setting information from the external device, the second print setting information being obtained by changing the first print setting information; and
a printing section that, when print data is received from the external device, processes the print data based on the second print setting information.

2. The image formation apparatus according to claim 1, further comprising:
a second transmission section that stores the second print setting information received by the first reception section in a storage and sends the external device location information of the stored second print setting information in the storage, wherein
when the print data including the location information is received from the external device, the printing section processes the print data based on the second print setting information, corresponding to the location information, in the storage.

3. The image formation apparatus according to claim 2, further comprising
the storage having an initial print setting information stored therein; and
a creation section that creates the first print setting information including the same information as the initial print setting information according to a request from the external device and stores the created first print setting information in the storage.

4. The image formation apparatus according to claim 3, wherein according to a request from the external device, the first transmission section reads the first print setting information from the storage and then sends the read first print setting information to the external device.

5. The image formation apparatus according to claim 3, wherein
the storage includes a first folder having the initial printing setting information stored therein,
the creation section creates a second folder in the storage and creates, in accordance with the request from the external device, the first print setting information in the second folder.

6. The image formation apparatus according to claim 3, wherein
the storage includes a plurality of folders and separately stores print setting items of the initial print setting information in respective folders of the plurality of folders, and
according to a request from the external device, the creation section separately creates the print setting items of the first print setting information in the respective folders.

7. The image formation apparatus according to claim 3, wherein
according to a request from the external device, the creation section creates tree information concerning a tree structure in the storage and sends the created tree information to the external device.

8. The image formation apparatus according to claim 3, wherein
the creation section reads from the storage, print setting information corresponding to location information included in the request from the external device and sends a summary of the read print setting information to the external device.

9. An image formation system comprising an image formation apparatus and an information processing apparatus, wherein
the image formation apparatus comprises:
a storage that stores first print setting information therein;
a first transmission section that sends the first print setting information to the information processing apparatus;
a first reception section that receives second print setting information from the information processing apparatus; and
a printing section that, when print data is received from the information processing apparatus, processes the print data based on the second print setting information, and
the information processing apparatus comprises:
a first communication section that acquires the first print setting information from the image formation apparatus;
a second communication section that sends the second print setting information and the print data to the image formation apparatus, wherein the second print setting information is obtained by changing the first print setting information.

10. The image formation system according to claim 9, wherein
the second communication section acquires, by sending the second print setting information to the image formation apparatus, location information of the second print setting information from the image formation apparatus, and
the second communication section sends the print data including the location information to the image formation apparatus.

11. The image formation system according to claim 9, wherein
the second communication section that requests, from the image formation apparatus, tree information concerning a tree structure in the storage of the image formation apparatus and acquires the tree information from the image formation apparatus, and
the information processing apparatus further comprises a display section that creates and displays a screen including the tree information.

12. The image formation system according to claim 11, wherein
the tree information includes information of at least one of a folder and a file,
the information processing apparatus further comprises an input section through which any one of the folder and file included in the tree information is selected when the tree information is displayed in the display section, and
the first communication section requests, from the image formation apparatus, the first print setting information corresponding to the one of the folder and file selected through the input section.

13. The image formation system according to claim 9, wherein
the information processing apparatus further comprises a search section that searches for the image formation apparatus capable of communicating with the information processing apparatus, wherein
the first communication section requests the first print setting information from the image formation apparatus searched out by the searching section.

14. An image formation method comprising
storing first print setting information
sending the first print setting information;
receiving the first print setting information;
sending second print setting information obtained by changing the first print setting information;
receiving the second print setting information;
sending print data; and
processing the print data based on the second print setting information, upon receiving the print data.

15. The image formation method according to claim 14, wherein
the first and second print setting information are stored in a storage.

16. The image formation method according to claim 15, further comprising
acquiring location information of the second print setting information in the storage, wherein
the sending of the print data comprises sending of the print data including the location information.

17. The image formation method according to claim 15, further comprising acquiring tree information concerning a tree structure in the storage; and
creating and displaying a screen including the tree information.

18. The image formation method according to claim 17, wherein
the tree information includes information of at least one of a folder and a file, and
the displayed screen comprises an input section through which any one of the folder and file included in the tree information is to be selected.

19. The image formation method according to claim 18, further comprising
requesting the first print setting information corresponding to the one of the folder and file selected through the input section.

20. The image formation method according to claim 14, further comprising:
searching for an image formation apparatus capable of communicating with an information processing apparatus; and
requesting the first print setting information from the searched image formation apparatus.
